(19) United States
(12) Patent Application Publication
(10) Pub. No.: US 2007/0044031 A1
(43) Pub. Date: Feb. 22, 2007

(54) A Method, System and Computer Program Product for Rendering a Graphical User Interface

(75) Inventors: Richard Lee Kulp, Cary, NC (US); Gili Mendel, Cary, NC (US); Joseph Robert Winchester, Hursley (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/464,904

(22) Filed: Aug. 16, 2006

(30) Foreign Application Priority Data
Aug. 16, 2005 (GB) 0516763.0

(51) Int. Cl. G06F 9/00; G11B 27/00

(52) U.S. Cl. 715/762; 715/764; 715/717

(57) ABSTRACT

A method of rendering a graphical user interface (GUI) model for a software application in a GUI builder, the method comprising the steps of: storing the application GUI model as a copy of the application GUI model in a buffer of the GUI builder; receiving a first GUI environment configuration at the GUI builder; receiving a second GUI environment configuration at the GUI builder, the second GUI environment configuration being different to the first GUI environment configuration; rendering a first representation of the copy of the application GUI model using GUI elements in accordance with the first GUI environment configuration; and reducing a second representation of the copy of the application GUI model using GUI elements in accordance with the second GUI environment configuration.

### FIELD OF THE INVENTION

The present invention relates to a builder for a graphical user interface. In particular, it relates to rendering a graphical user interface model.

### BACKGROUND OF THE INVENTION

Graphical user interface (GUI) builders are software tools used in the development of graphical user interfaces for application in computer systems. Such tools offer a developer facilities for designing, laying out and visualising or otherwise representing a GUI. To achieve this the tool generates a model of a GUI in accordance with the requirements of the developer and/or a specification, and offers facilities for rendering the GUI model to provide a tangible representation of the final GUI.

FIG. 1 is an exemplary block diagram of a graphical user interface builder in the prior art. The GUI builder includes a GUI modeller 102, such as a software tool for use by a developer for specifying and modelling a desired GUI, which generates a GUI model 104. The GUI model 104 includes a specification of GUI windows and controls. For example, the GUI model 104 is a textual, descriptive or code-based document model for a GUI. Such modellers are well known in the art in such fields as rapid application development (RAD) and component based development. The GUI builder further includes a GUI renderer 106 which is operable to receive the GUI model 104 and a GUI environment configuration 108 to render a representation 110 of the GUI model 104 and record such a representation to a storage or output device 112. For example, the GUI renderer 106 is a graphical image renderer which generates a graphical image representation of the GUI model 104 for storing in a graphical file format or displaying on a visual display unit. Alternatively, the GUI renderer can be a user interface emulator which provides a representation of the GUI model 104 using GUI emulation techniques such as emulated windows and controls. As a further alternative the GUI renderer 106 can be an instantiator of actual GUI objects from an object oriented user interface class library, such as the abstract windowing toolkit or Swing class libraries used with the Java programming language (Java is a registered trademark of Sun Microsystems Inc.).

The GUI environment configuration 108 is a set of specifications of attributes of the user interface environment with which the GUI renderer 106 will generate the representation 110 of the GUI model 104. For example, the GUI environment configuration 108 can include such attributes as: a particular locale for the user interface; a window or GUI control scale factor (e.g. zooming into or out of windows); window size or dimension information; font style and size information; colour information; window border dimensions; scroller dimensions; and particular paint characteristics. As will be apparent to those skilled in the art, many other attributes and characteristics can also be defined as part of the GUI environment configuration. The GUI renderer 106 uses the particular GUI environment configuration 108 to generate the representation 110 of the GUI model 104.

Whilst the GUI builder of FIG. 1 is effective in providing facilities for developing and representing a GUI for an application, it suffers the drawback that the GUI environment configuration 108 is not necessarily representative of the particular GUI environment configuration used by end-users of a software application. For example, different locales and window sizes can be used by different individuals and a GUI developer will only be able to develop a GUI with a single GUI environment configuration in mind at any one time. Furthermore, a GUI developer who wishes to render the GUI model for different GUI environments is required to change the GUI environment and have the GUI renderer access the GUI model multiple times. This is particularly time consuming as the GUI renderer is required to make multiple accesses to the GUI model.

It would therefore be advantageous to provide for the development of a GUI intended for use in a range of different GUI environment configurations.

### SUMMARY OF THE INVENTION

The present invention accordingly provides, in a first aspect, a method of rendering a graphical user interface (GUI) model for a software application in a GUI builder, the method comprising the steps of: storing the application GUI model as a copy of the application GUI model in a buffer of the GUI builder; receiving a first GUI environment configuration at the GUI builder; receiving a second GUI environment configuration at the GUI builder, the second GUI environment configuration being different to the first GUI environment configuration; rendering a first representation of the copy of the application GUI model using GUI elements in accordance with the first GUI environment configuration; and rendering a second representation of the copy of the application GUI model using GUI elements in accordance with the second GUI environment configuration.

Preferably the application GUI model includes a specification of a GUI windows and controls.

Preferably the first and second GUI environment configurations include at least one of: a locale specification; control scale information; window scale information; window zoom information; and font information.

Preferably the first GUI environment includes a locale specification which is different to the second GUI environment.

Preferably the rendering a first representation step includes generating a graphical representation of the copy of the application GUI model.

Preferably the rendering a first representation step includes initiating GUI controls in the GUI builder.

Preferably the rendering a first representation step includes emulating GUI controls in the GUI builder.

Preferably the rendering a second representation step includes generating a graphical representation of the copy of the application GUI model.

Preferably the rendering a second representation step includes instantiating GUI controls in the GUI builder.

Preferably the rendering a second representation step includes emulating GUI controls in the GUI builder.

The present invention accordingly provides, in a second aspect, a system for rendering a graphical user interface (GUI) model for a software application in a GUI builder, the system comprising: means for storing the application GUI model as a copy of the application GUI model in a buffer of the GUI builder; means for receiving a first GUI environment configuration at the GUI builder; means for receiving a second GUI environment configuration at the GUI builder, the second GUI environment configuration being different to the first GUI environment configuration; means for rendering a first representation of the copy of the application GUI model using GUI elements in accordance with the first GUI environment configuration; and means for rendering a second representation of the copy of the application GUI model using GUI elements in accordance with the second GUI environment configuration.

The present invention accordingly provides, in a third aspect, a computer program product comprising computer program code which, when executed on a data processing system, instructs the data processing system to carry out the method as described above.

The present invention accordingly provides, in a fourth aspect, a data processing system comprising: a central processing unit; a memory subsystem; an input/output subsystem; and a bus subsystem for interconnecting the central processing unit, the memory subsystem, the input/output subsystem; and a system as described above.

### BRIEF DESCRIPTION OF THE DRAWINGS

A preferred embodiment of the present invention will now be described, by way of example only, with reference to the accompanying drawings, in which:

FIG. 1 is an exemplary block diagram of a graphical user interface builder in the prior art;

FIG. 2 is an exemplary block diagram of a computer system suitable for the operation of embodiments of the present invention;

FIG. 3 is an exemplary block diagram of a graphical user interface builder in accordance with a preferred embodiment of the present invention;

FIG. 4 is a flowchart for a method of the graphical user interface renderer of FIG. 3 in accordance with a preferred embodiment of the present invention; and

FIG. 5 is an exemplary block diagram of a graphical user interface builder in use in accordance with a preferred embodiment of the present invention.

### DETAILED DESCRIPTION OF THE PREFERRED EMBODIMENT

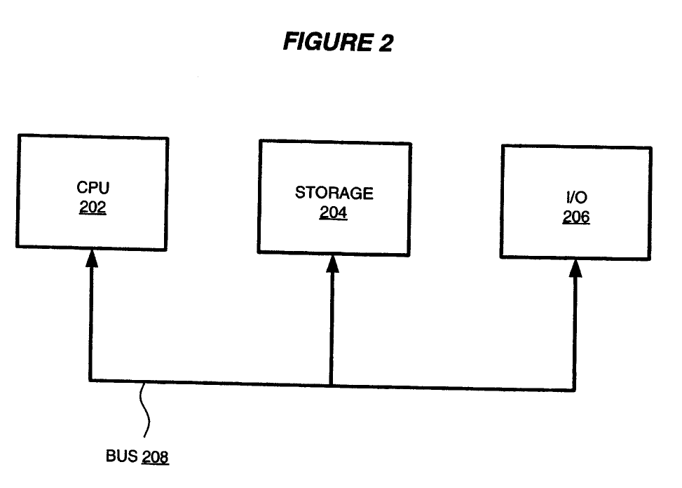

FIG. 2 is a block diagram of a computer system suitable for the operation of embodiments of the present invention. A central processor unit (CPU) 202 is communicatively connected to a storage 204 and an input/output (I/O) interface 206 via a data bus 208. The storage 204 can be any read/write storage device such as a random access memory (RAM) or a non-volatile storage device. An example of a non-volatile storage device includes a disk or tape storage device. The I/O interface 206 is an interface to devices for the input or output of data, or for both input and output of data. Examples of I/O devices connectable to I/O interface 206 include a keyboard, a mouse, a display (such as a monitor) and a network connection.

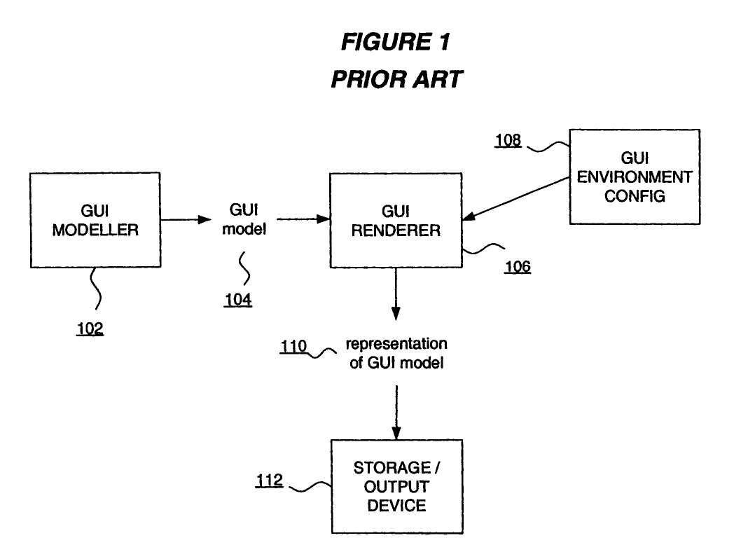

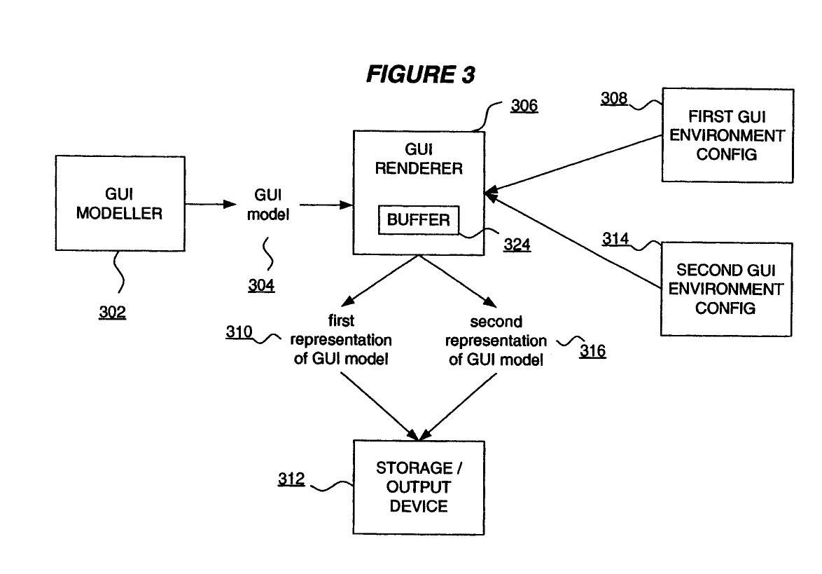

FIG. 3 is an exemplary block diagram of a graphical user interface builder in accordance with a preferred embodiment of the present invention. Many of the elements of FIG. 3 are identical to those described earlier with respect to FIG. 1 and these will not be repeated here. FIG. 3 includes a first GUI environment configuration 308 and a second GUI environment configuration 314 to accommodate different GUI environments in the development of representations of the GUI model 304. whilst two GUI environment configurations are illustrated in FIG. 3, it will be appreciated by those skilled in the art that any number of GUI environment configurations could be used. The GUI renderer 306 includes a buffer 324, such as a memory buffer. The buffer 324 is operable to receive and store a copy of the GUI model 304. The GUI renderer 306 generates a first representation 310 of the copy of the GUI model 304 stored in the buffer 324 in accordance with the first GUI environment configuration 308. The GUI renderer 306 also generates a second representation 316 of the copy of the GUI model 304 stored in the buffer 324 in accordance with the second GUI environment configuration 314. The first and second representations 310, 316 are recorded on a storage device or output device 312. For example, device 312 can be a visual display, a disk storage device, a printer or other storage or output device.

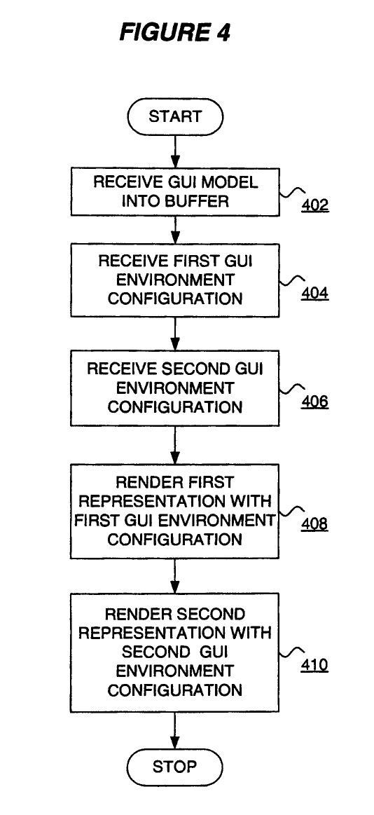

FIG. 4 is a flowchart for a method of the graphical user interface renderer of FIG. 3 in accordance with a preferred embodiment of the present invention. At step 402, the GUI renderer 306 receives the GUI model 304 into the buffer 324 of the GUI renderer 306. The GUI model 304 can be received from the GUI modeller 302. At step 404 the GUI renderer 306 receives the first GUI environment configuration 308 and at step 306 the GUI renderer receives the second GUI environment configuration 314. For example, the first and second GUI environment configurations 308, 314 are received from a storage device of a computer system, or are defined by a developer of the computer system. It will be apparent to those skilled in the art that additional steps equivalent to steps 404 and 406 can be undertaken for further, additional, GUI environment configurations in any particular embodiment of the present invention. Subsequently, at step 408, the GUI renderer 306 generates the first representation 310 of the GUI model 304 in accordance with the first GUI environment configuration 308. Finally, at step 410, the GUI renderer 306 generates the second representation 316 of the GUI model 304 in accordance with the second GUI environment configuration 314. It will also be apparent to those skilled in the art that additional steps equivalent to steps 408 and 410 can be undertaken to generate further representations of the GUI model 304 for further, additional, GUI environment configurations in any particular embodiment of the present invention. In this way the GUI renderer 306 is able to provide a developer with representations of the GUI model 304 in accordance with multiple and different GUI environment configurations, such as multiple window sizes and/or multiple locales, at the same time.

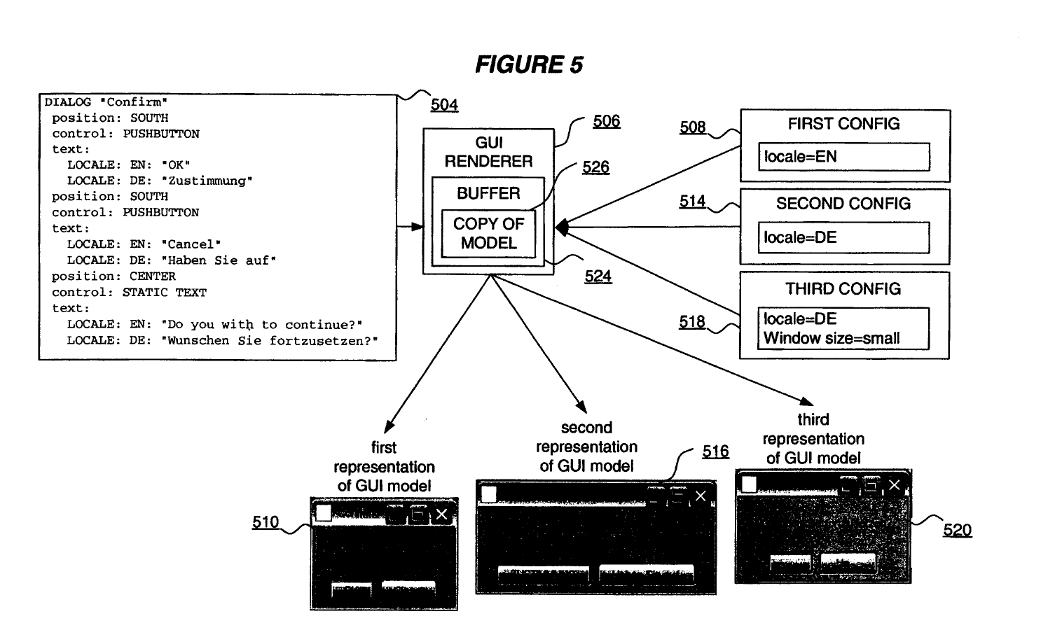

A preferred embodiment of the present invention will now be considered in use. FIG. 5 is an exemplary block diagram of a graphical user interface builder in use in accordance with a preferred embodiment of the present invention. In the GUI builder of FIG. 5, a GUI model 504 comprises a textual description of a model of a user interface dialog window. It will be apparent to those skilled in the art that the textual description of GUI model 504 is entirely exemplary, and could alternatively be a GUI model known in the art such as a document object model (DOM). As is clear from the GUI model 504 of FIG. 5, the GUI model 504 defines a dialog window with the title “Confirm”. Positioned to the ‘south’ of the dialog window are two GUI pushbutton controls. Pushbuttom controls are GUI representations of pushable buttons as are well known in the art. A first pushbutton control has one of two textual labels dependent upon a locale in an active GUI environment configuration. In a locale named “EN” (English) the label of the first pushbutton is “OK”. In a locale named “DE” (German) the label of the first pushbuttom is “Zustimmung”. A second pushbutton control also has one of two textual labels dependent upon a locale in an active GUI environment configuration. In the locale named “EN” the label of the second pushbutton is “Cancel”. In the local named “DE” the label of the second pushbutton is “Haben Sie auf. Positioned to the ‘center’ of the dialog window is a single static text control. Static text controls are GUI representations of textual strings as are well known in the art. The static text control has one of two textual values dependent upon a locale in an active GUI environment configuration. In the locale named “EN” the label of the static text is “Do you wish to continue?“. In the locale named “DE” the label of the static text is “Wunschen Sie fortzusetzen?”.

The GUI builder of FIG. 5 also includes three GUI environment configurations 508, 514 and 518. A first GUI environment configuration 508 is configured such that the locale is “EN” (English). A second GUI environment configuration 514 is configured such that the locale is “DE” (German). A third GUI environment configuration 518 is configured such that the locale is “DE” and the window size is “small”. It will be appreciated by those skilled in the art that other attributes may be included in a definition of a GUI environment configuration such as: a particular locale for the user interface; a window or GUI control scale factor (e.g. zooming into or out of windows); window size or dimension information; font style and size information; colour information; window border dimension; scroller dimensions; and particular paint characteristics.

In use, a GUI renderer 506 of FIG. 5 receives the GUI model 504 and stores a copy of the GUI model 526 in the buffer 524. The GUI renderer 506 then generates multiple representations of the copy of the GUI model 526 in accordance with the GUI environment configurations 508, 514 and 518 using the method of FIG. 4. Firstly, at step 402, the GUI renderer 506 receives as input the GUI model 504 into the buffer 524 as a copy of the GUI model 526. Alteratively, the GUI renderer 506 reads the GUI model 504 from a storage device, such as a disk storage, or from a network connection, and stores it in the buffer 524. At steps 404 and 406 the GUI renderer 506 receives the first and second GUI environment configurations 508, 514. Additionally, in a further step additional to FIG. 4, the GUI renderer 506 receives a third GUI environment configuration 518. Subsequently, at step 408, the GUI renderer 506 generates a first representation 510 of the copy of the GUI model 526 in accordance with the first GUI environment configuration 508. As can be seen in FIG. 5, the first representation 510 employs the window and control text of the locale named “EN” as defined in the GUI model 504 and the first GUI environment configuration 508. The first representation 510 of the GUI model is therefore useful to prove the effect of the GUI model in GUI environments according to the first GUI environment configuration 508.

Subsequently, at step 410, the GUI renderer 506 generates a second representation 510 of the copy of the GUI model 526 in accordance with the second GUI environment configuration 514. As can be seen in FIG. 5, the second representation 516 employs the window and control text of the locale named >>DE” as defined in the GUI model 504 and the second GUI environment configuration 514. The second representation 516 of the GUI model is therefore useful to prove the effect of the GUI model in GUI environments according to the second GUI environment configuration 514.

Subsequently, in a further step additional to those of FIG. 4 to accommodate the third GUI environment configuration 518, the GUI renderer 506 generates a third representation 520 of the copy of the GUI model 526 in accordance with the third GUI environment configuration 518. As can be seen in FIG. 5, the third representation 520 employs the window and control text of the locale named “DE” as defined in the GUI model 504 and the third GUI environment configuration 518. Also, the third representation 520 employs a small window size in accordance with the third GUI environment configuration 518. The window size of the third representation is so small, in fact, that the relatively lengthy text for the GUI defined for the *DE” locale is too long for the pushbutton controls. Thus, the third representation 520 of the GUI model is useful to prove the undesirable effect of the GUI model in GUI environments according to the third GUI environment configuration 520, and therefore highlights: defects in the GUI model 504; defects in a GUI design from which the model is developed; or GUI environment limitations of the GUI model 504.

In tis way the GUI renderer 506 is able to generate multiple representations of the GUI model 504 whilst only receiving the GUI model 504 once by storing the GUI model 504 as a copy of the GUI model 526 in the buffer 524.

1. A method of rendering a graphical user interface (GUI) model for a software application in a GUI builder, the method comprising the steps of:
storing the application GUI model as a copy of the application GUI model in a buffer of the GUI builder;
receiving a first GUI environment configuration at the GUI builder;
receiving a second GUI environment configuration at the GUI builder, the second GUI environment configuration being different to the first GUI environment configuration;
rendering a first representation of the copy of the application GUI model using GUI elements in accordance with the first GUI environment configuration; and
rendering a second representation of the copy of the application GUI model using GUI elements in accordance with the second GUI environment configuration.

2. The method of claim 1 wherein the application GUI model includes a specification of GUI windows and controls.

3. The method of claim 1 wherein the first and second GUI environment configurations include at least one of: a locale specification; control scale information; window scale information; window zoom information; and font information.

4. The method of claim 3 wherein the first GUI environment includes a locale specification which is different to the second GUI environment.

5. The method of claim 1 wherein the rendering a first representation step includes generating a graphical representation of the copy of the application GUI model.

6. The method of claim 1 wherein the rendering a first representation step includes instantiating GUI controls in the GUI builder.

7. The method of claim 1 wherein the rendering a first representation step includes emulating GUI controls in the GUI builder.

8. The method of claim 1 wherein the rendering a second representation step includes generating a graphical representation of the application GUI model.

9. The method of claim 1 wherein the rendering a second representation step includes instantiating GUI controls in the GUI builder.

10. The method of claim 1 wherein the rendering a second representation step includes emulating GUI controls in the GUI builder.

11. A system for rendering a graphical user interface (GUI) model for a software application in a GUI builder, the system comprising:
means for storing the application GUI model as a copy of the application GUI model in a buffer of the GUI builder;
means for receiving a first GUI environment configuration at the GUI builder;
means for receiving a second GUI environment configuration at the GUI builder, the second GUI environment configuration being different to the first GUI environment configuration;
means for rendering a first representation of the copy of the application GUI model using GUI elements in accordance with the first GUI environment configuration; and
means for rendering a second representation of the copy of the application GUI model using GUI elements in accordance with the second GUI environment configuration.

12. The system of claim 11 wherein the application GUI model includes a specification of GUI windows and controls.

13. The system of claim 11 wherein the first and second GUI environment configurations include at least one of: a locale specification; control scale information; window scale information; window zoom information; and font information.

14. The system of claim 13 wherein the first GUI environment includes a locale specification which is different to the second GUI environment.

15. The system of claim 11 wherein the means for rendering a first representation includes means for generating a graphical representation of the copy of the application GUI model.

16. The system of claim 11 wherein the means for rendering a first representation includes means for instantiating GUI controls in the GUI builder.

17. The system of claim 11 wherein the means for rendering a first representation includes means for emulating GUI controls in the GUI builder.

18. The system of claim 11 wherein the means for rendering a second representation includes means for generating a graphical representation of the copy of the application GUI model.

19. The system of claim 11 wherein the means for rendering a second representation step includes means for instantiating GUI controls in the GUI builder.

20. The system of claim 11 wherein the means for rendering a second representation includes means for emulating GUI controls in the GUI builder.
